(19) United States
(12) Patent Application Publication
(10) Pub. No.: US 2008/0276933 A1
(43) Pub. Date: Nov. 13, 2008

(54) Headgear

(75) Inventors: Ian Dampney, Middlesex (GB); Simon Peter Smith, Bedfordshire (GB); Colin Church, Hertfordshire (GB)

Correspondence Address: HAYNES BEFFEL & WOLFELD LLP, P O BOX 366, HALF MOON BAY, CA, 94019, US

(73) Assignee: HELMET INTEGRATED SYSTEMS LIMITED, Letchworth, Hertfordshire (DE)

(21) Appl. No.: 10/597,138

(22) PCT Filed: Jan. 12, 2005
(86) PCT No.: PCT/GB2005/000065

§ 371 Date: Jul. 24, 2008

(30) Foreign Application Priority Data
Jan. 12, 2004 (GB) 0400572.4
Jan. 15, 2004 (GB) 0400871.0
Apr. 26, 2004 (GB) 0409258.1
Jun. 29, 2004 (GB) 0414563.7

(51) Int. Cl. A62B 7/10; A62B 17/04; A62B 17/00; A42B 1/24; A42C 5/00; A42B 1/04

(52) U.S. Cl. 128/201.25; 128/201.22; 128/201.29; 128/205.29; 2/422; 2/171.2; 2/202

(57) ABSTRACT

A personalised cap (10) for use with a protective helmet is disclosed, having crown and brow portions (12, 14). The brow portion (14) is removable independently of the crown portion (10), and an alternative brow portion (14′) is provided for use when a environmental protection hood is to be worn under the helmet. An alternative crown portion (12′) also may be provided. A hood for use over a helmet and a hose for use to provide air to a respiratory mask, a mask and fittings for attaching a mask to a helmet are also disclosed. The environmental protection hood may comprise a manifold (412) having an element external to the hood, for receiving supply of services needed within the hood, and an element internal to the hood, for providing those services where required.

The present invention relates to headgear. In one alternative, the invention relates in particular, but not exclusively, to a personalised internal cap for a helmet, a helmet comprising a personalised internal cap, a method of manufacturing such a helmet and protective apparel comprising such a helmet, wherein the internal cap is personalised such that the helmet sits in a predetermined position on a wearer's head. In a second alternative, the invention relates, in particular, but not exclusively, to an environmental protection hood. In a third alternative, the invention relates to breathing equipment and in particular, but not exclusively, to breathing masks, such as those worn by the pilots of military aircraft.

The invention is particularly suitable for the fitting of helmets for pilots of military aircraft. Such helmets typically comprise an outer protective helmet and, attached to the outer helmet, a helmet mounted display system. Such systems require exact and repeatable placement of images in front of the wearer's eyes during flight. A poorly-fitting helmet tends to move relative to the head during use, thus causing the display to be displaced relative to the line of sight of the wearer. This is particularly important if the display is for a weapon-aiming system. A poorly-fitting helmet also causes the weight of the helmet to be focussed on pressure points, resulting in user discomfort.

In some situations it is necessary for the wearer to wear an environmental protection hood, within or outside the helmet. Such hoods typically have a plurality of tubes extending through the hood at various locations to supply services such as air, oxygen liquid and communications to the wearer. Each of these penetrations of the hood is a potential leakage path and hazard. Additionally, the presence of the hood may result in the helmet not sitting in the necessary position for acceptable operation of the external helmet-mounted equipment. In addition, the hood may cause discomfort to the wearer. Tailoring hoods to prevent this may not be cost-effective. In addition, the material from which the hood is made may not be conducive to an accurate and repeatable fit of the helmet to the head of the wearer, for example since it slips against the hair of the wearer.

Additionally, the pilot of a military aircraft typically wears a breathing mask which is attached by straps for, example, to a helmet. The mask has to be located within the hood so that a problem arises when connecting the mask to the helmet, in the event that the hood is worn under the helmet. If openings are provided in the hood to receive straps connecting the mask to the helmet, the openings will need to be sealed to ensure the integrity of the hood. If the seals become damaged or distorted in use, the health of the pilot may be placed at risk. Similar problems may arise in the case of breathing masks provided for use of those working in toxic atmospheres.

An aspect of this invention, whose aim is to overcome or alleviate one or more of these problems, provides an environmental protection hood comprising a manifold having an element external to the hood, for receiving supply of services needed within the hood, and an element internal to the hood, for providing those services where required.

Provision of all the services at a specialised manifold assists in enabling a variety of different hoods, masks and helmets to be used together. Furthermore, it assists in stabilising the hood in use. An exoskeleton may be provided with the manifold, as described hereinafter, which greatly assists the stabilisation. Additionally, the provision of a manifold in this way may eliminate the necessity for a plurality of openings in the hood and thereby reduce the likelihood of failure due to leakage around such an opening. Additional inlets and outlets may be added to the hood much more easily, being sealed to the manifold.

The external element may have an inlet for receiving a breathing supply and/or the internal element may have an outlet for feeding an oxygen mask.

The external element may have an inlet for receiving a liquid.

The external element may have an inlet for receiving air and the internal element may have an outlet for feeding a demisting jet of air for demisting or inhibiting misting of a window of the hood and/or an outlet for ventilating the hood.

Preferably the inlet for receiving air is disposed within the inlet for receiving a breathing supply or vice versa.

A supply conduit assembly for connection to a hood according to the first aspect of the invention may be provided comprising a breathing gas conduit, an air conduit and a diverter for diverting air from the air conduit to the breathing conduit if a supply of breathing gas is insufficient.

The assembly may comprise a powered impeller for increasing air pressure in the air conduit.

The air conduit may comprise a filter for removing contaminants from the air passing therethrough.

The diverter may comprise a normally-closed valve between the breathing gas conduit and the air conduit.

The assembly may comprise a non-return valve to prevent air flowing back from the hood when air is diverted to the breathing conduit.

A manifold for a hood according to the first aspect of the invention or for an assembly as set out above may also be provided.

A further aspect of the invention, whose aim is to overcome or alleviate one or more of the above problems, provides a personalised cap for a helmet, the cap being bespoke to a specific wearer so as precisely to fit the helmet to the wearer's head, the cap comprising a crown portion and a separate brow portion, the crown and brow portion being contiguous with each other.

The provision of a tailored cap in this way allows the general use of hoods and helmets provided in a limited number of sizes. In addition, the hood may be formed of a material best-suited to the protective purpose which the hood is intended to perform, while the cap is formed of a material which will not slide against the hair of the wearer.

A further aspect of the invention provides an environmental protection hood for use under a protective helmet, comprising an aperture containing a window adjacent the periphery of which is adapted to engage with a personalised cap according to the second aspect of the invention.

Such a hood may serve to locate accurately the window relative to the head of a wearer.

Yet a further aspect provides a helmet comprising a personalised cap as set out above.

A further aspect provides a method of manufacturing a helmet comprising a personalised internal cap which positions the helmet on the wearer's head, the method comprising a prior determination of the shape of the wearer's head by a measurement device followed by the production of a kit of parts for assembly into said personalised cap, the kit comprising a crown portion and alternative brow portions, a first said brow portion conforming to the wearer's head when wearing an environmental protection hood, and a second said brow portion conforming to the wearer's head without said hood. There may also be provided alternative crown portions, a first said crown portion conforming to the wearer's head when wearing an environmental protection hood, and a second said crown portion conforming to the wearer's head without said hood.

Yet a further aspect provides a kit of parts for precisely fitting a helmet to a wearer's head, the kit comprising a crown portion and first and second brow portions of a personalised internal cap which position the helmet on the wearer's head, the first and second brow portions having respectively been produced to align the helmet on the wearer's head to a predetermined position relative to his eyes when the wearer respectively is wearing and is not wearing an environmental protection hood. The kit may also comprise a second crown portion, the first and second crown portions having respectively been produced to align the helmet on the wearer's head to a predetermined position relative to his eyes when the wearer respectively is wearing and is not wearing an environmental protection hood.

The individual components of the kit of parts may also be provided separately, or in any combination. Thus the invention also provides a crown portion of a personalised cap for a helmet, the crown portion conforming to the shape of a wearer's head. The invention also provides, independently, first and second brow portions of a personalised cap for a helmet, the brow portions conforming to the shape of a particular wearer's head when not wearing and when wearing an environmental protection hood, respectively.

A related aspect of the invention provides a helmet comprising a personalised internal cap formed from a kit of parts as set out above, and a further aspect provides protective apparel comprising such a helmet or a helmet as set out above.

Yet a further aspect of the invention provides an environmental protection hood for use under a protective helmet, comprising an aperture containing a window adjacent the periphery of which is adapted to engage with a personalised cap according to one of the above aspects of the invention.

A further aspect of the invention provides an air supply system for supplying air to an oxygen mask, comprising a junction having a pressure switch adapted to supply air to a mask from a pressurised source when such is present and, in the absence of a pressurised source, from a secondary source adapted to be positively buoyant in water.

Yet a further aspect provides a device for supplying air to an oxygen mask, comprising an air inlet, an outlet for carrying air towards the mask, the device being adapted to become positively buoyant in water upon contact with water.

A further aspect provides a buoyancy aid or life vest comprising a device according to the preceding aspect.

A hood according to any of the aspects set out above may further comprise fittings for engaging with a respiratory mask to locate such a mask when used by a wearer of the hood. The provision of fittings on the hood for attaching a mask rather than attaching the mask to the helmet may divorce the location of the mask from that of the helmet, in a hood formed of a flexible material. This enables variations in the facial lengths of different users to be better accommodated. This may provide increased comfort for the wearer, particularly when under exertion.

Preferably, such a hood further comprises a removable mask portion. The provision of a removable mask portion of the hood, for example, around the mouth (and preferably nose) of the wearer, such that when the portion is removed the mouth (and nose) are exposed, may increase the comfort of the wearer of the hood in an analogous way as the provision of a removable window.

Preferably, the mask portion comprises a further rigid frame adapted to seal against the rigid frame. This may allow the removable mask portion to be reattached to the main body of the hood rapidly and securely.

The fittings for attaching a mask are preferably provided on the rigid frame of the mask portion, since this may allow the mask portion and mask to be attached and removed in one operation.

Yet a further aspect of the invention provides an environmental protection hood for use over a helmet and a respiratory mask, the hood being adapted to entirely enclose the helmet and mask.

Such a hood may eliminate the need for decontamination of a helmet and mask or for the discarding of the helmet and mask, which may be necessary when using hoods in which the helmet and mask are exposed. In addition, masks used with such a hood need themselves be protective, and a wearer may use a single mask regardless of whether a hood is to be worn.

The hood may comprise an aperture having situated therein a window through which a wearer of the hood may see, a selectively releasable seal being provided adjacent an edge of the window such that an opening may be made in the hood. In this way, the wearer of the hood may easily create an opening in the hood in conditions where the wearing of the hood is not necessary (but may be anticipated), thereby increasing his comfort. This feature is also provided independently.

The hood may preferably be worn with a helmet having a front portion which may be raised and lowered by the wearer and it therefore preferably comprises means for engaging the window with a raisable front portion of a helmet, such that when the hood and helmet are worn together, the window and the front portion of the helmet may be raised and lowered together. This may further serve to increase the comfort of the wearer.

Preferably, the hood further comprises fittings for engaging with a respiratory mask to locate such a mask when used by a wearer of the hood.

Hoods in accordance with the preceding aspects of the invention (whether for use over or under a helmet) preferably further comprise a sleeve adapted to receive a hose for delivering air to a respiratory mask worn by a wearer of the hood. In this way, it is not necessary that the hose itself is protective since it is enclosed by the sleeve. A single hose may therefore be used regardless of whether a hood is to be worn. This feature is also provided independently.

The sleeve is preferably formed of the same material as the hood so that it too forms part of the enclosure of the hood, which thereby also protects the hose.

Preferably, the distal end of the sleeve with respect to the aperture of the hood has an element inside the sleeve for engaging with a hose by means of which the hose may be fed with air and an element outside the sleeve for engaging with an air supply means of an aircraft, by means of which the hose may be fed with air.

The sleeve preferably further comprises at its distal end an element for attaching a further hose for providing demisting air to the hood adjacent the head of a wearer and has a further hose for providing that demisting air which runs within the sleeve from its distal end to a portion of the hood adapted in use to be adjacent the head of a wearer, where it may be directed, for example, onto the inside of the window of the hood.

A further aspect of the invention provides a respiratory mask air supply hose comprising an enclosure forming a conduit through which air may pass and a structural element for maintaining the cross-section of the conduit.

The structural element is preferably formed of a thermoplastic material.

Preferably, the structural element comprises a left-handed helix and a right handed helix, both helices being coaxial with the conduit. In comparison with known hoses air conduits which have a structural element formed of a single helix, such a structural means may have greater structural stability. This feature is also provided separately.

Preferably, the helices are arranged such that, when the hose is compressed or extended, substantially zero torque around the axis of the hose results In this way, if the user of the hose moves towards or away from an air source to which the hose is attached, the likelihood of accidental detachment of the hose by rotation of the attached end under a resultant torque and the risk of a kink forming in the hose may be reduced.

Preferably, the structural element comprises a plurality of left-handed helices and/or a plurality of right-handed helices. This may allow mechanical characteristics of the hose (e.g. stiffness) to be tailored to particular applications.

The structural element may comprise a mesh. The structural element may be extruded.

The structural element may be formed of different material from that of the enclosure. In comparison with known hoses which are formed entirely of moulded silicone and which have integral ribs to maintain the structure of the hose, such a hose may be made to be lighter by selection of an appropriate material for the structural means, which may in turn result in greatly reduced load on the head of a wearer, particularly under rapid acceleration.

A further aspect provides a respirator mask comprising a first portion (which is preferably injection moulded) housing at least one valve and a second portion (for example, formed of silicone rubber) adapted to seal around the nose and mouth of a wearer, the first and second portions being formed of different materials.

Known respirator masks are largely formed of a flexible material such as silicone rubber in order to provide sufficient flexibility for the mask to seal around the nose and mouth of a wearer. The rigidity necessary for the portion of the mask housing the inspiratory and expiratory valves and the communications components is achieved by means of larger wall sections. In comparison with such known masks, a mask according to this aspect may be lighter since the necessary rigidity may be achieved by thinner wall sections of a less dense material (e.g. a thermoplastics material such as nylon, PA or POM). In addition, the centre of gravity of the mask may be moved towards the seal of the mask. Both the reduced weight and the movement of the centre of gravity are of particular importance where the wearer of the mask is to be subjected to increased accelerational forces, where they may result in a reduced load on the neck of the wearer. This may result in the mask being usable in conditions where the wearer is subjected to yet greater accelerational forces. Furthermore, the tension necessary to securely locate the mask in place may be reduced, resulting in greater comfort for the wearer.

Preferably, the first portion of the mask has at least one integrally-formed portion of a valve. This feature is also provided independently. In known masks, the valves are self-contained units made, tested and sold separately and inserted into the mask. The mask is therefore relatively large since it accommodates both the wall thickness necessary to give the structural portion of the mask rigidity and the wall thickness of the valves. The provision of a portion of the valve (for example, a valve seat or a chamber of an inspiratory or expiratory valve) integrally with the portion of the mask may reduce the overall wall thickness of the mask, perhaps resulting in a yet lighter, more compact mask having the advantages set out above. In addition, the reduced number of interfaces between components of the mask may reduce the likelihood of leaks forming around valves.

A further aspect of the invention provides a fitting for attaching a respirator mask to a helmet, the fitting comprising a helmet connector for engaging with a helmet, and a mask connector for receiving webbing for attaching the fitting to the mask, the mask connector being adapted to be movable such that the direction at which webbing in the mask connector extends from the fitting relative to the position of the helmet engaging means may be adjusted. In this way, the attitude of a mask attached to the fitting may be adjusted independently of the attitude of the fitting relative to the helmet, which may result in increased comfort for a wearer.

Preferably, the fitting comprises a plurality of independently-moveable mask connectors. This may result in greater security in the attitude of the mask relative to the fitting.

The mask connector preferably comprises a disc rotatably-mounted in the fitting, the disk comprising a slot for receiving webbing and/or an arcuate insert slidably mounted in an arcuate slot in the fitting, the insert comprising a further slot for receiving webbing.

According to a further aspect of the present invention a breathing mask has a component for location within the hood and a component for location externally of the hood. Preferably the external component may be attached to the helmet, and preferably the external component is adapted to capture the material of the hood between the internal component and the external component.

Preferably one of the components being provided or associated with a projection capable of being pressed into the material of the hood, and the other component having an opening for receiving and retaining the projection and the portion of the hood to which it is applied.

Preferably the projection has an enlarged head which, together with the portion of the hood, is retained in the opening eg. as a snap-fit. The projection may be of mushroom-like form and be provided on a face piece of the mask for reception, together with the portion of hood covering it, in an opening in a cover located on the outside of the hood. The cover is provided with fitments for attachment of straps securing the cover to the helmet. Although the opening in which the projection is received may pass entirely through the cover, it will be appreciated that the opening may be in the form of a depression in the cover, the depression having a constricted rim to grip the projection.

A problem experienced by the wearers of breathing masks is that changes of external air pressure lead to an imbalance in air pressure across the ear drum, and to discomfort for the wearer. Some way of equalising the air pressure is therefore needed and typically this is achieved by pinching the nose, clenching the lips and exerting pressure as by exhaling, a technique known as valsalva. In the case of a pilot or worker who is required to wear goggles, pinching the nose may not be practicable. The ability to pinch the nose effectively may also be restricted if thick gloves are being worn. A conventional breathing mask includes an outlet port provided with an expiratory valve which opens as the wearer exhales and through which the exhalate is vented. According to a further aspect of the invention, the port may be provided with a part which may be depressed by finger or thumb pressure to close the port. The cover may be so shaped by, for example, being dished, so as to allow the wearer to locate it with ease, even when wearing thick gloves. With the port closed, the wearer may exhale vigorously, and it is found that the effect of this is to equalise the pressure in the ear canals.

The various aspects of the invention need not be employed together, but either may be employed in a breathing mask without the other.

Other preferred features of all of the above aspects are set out in the dependent claims.

Specific embodiments will now be described, by way of example only, with reference to the accompanying drawings, in which:

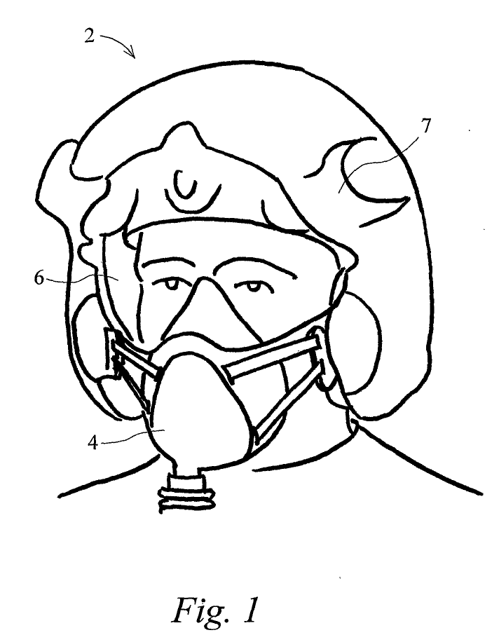

FIG. 1 shows an impact-resistant and energy absorbing helmet in use;

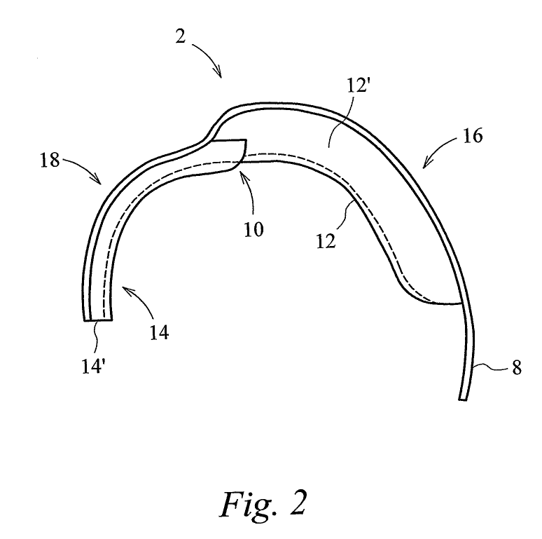

FIG. 2 is a part section through the helmet shown in FIG. 1 with mask, visor and helmet-mounted equipment removed and showing a personalised cap;

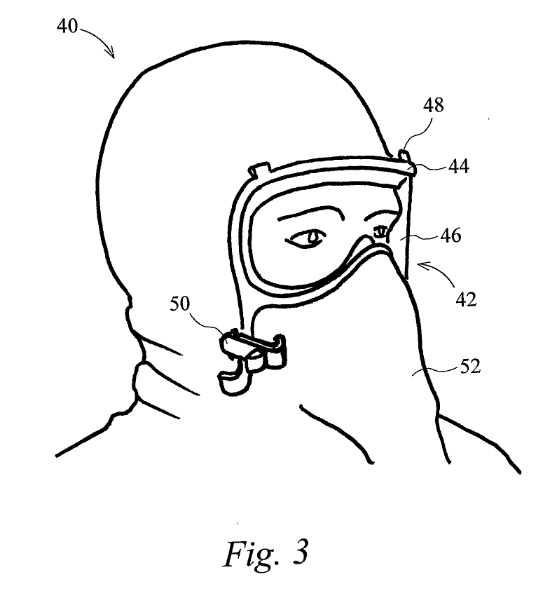

FIG. 3 shows a first hood adapted to be worn under the helmet shown in FIGS. 1 and 2;

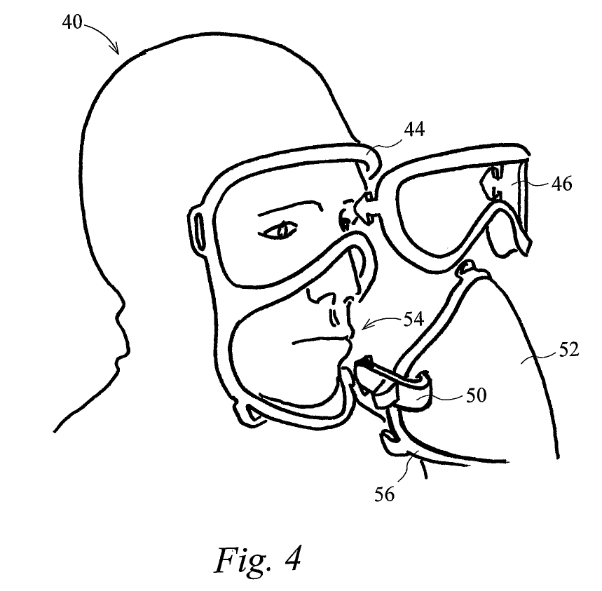

FIG. 4 shows a second hood adapted to be worn under the helmet shown in FIGS. 1 and 2, illustrating the removable goggle and mask portion of the hood;

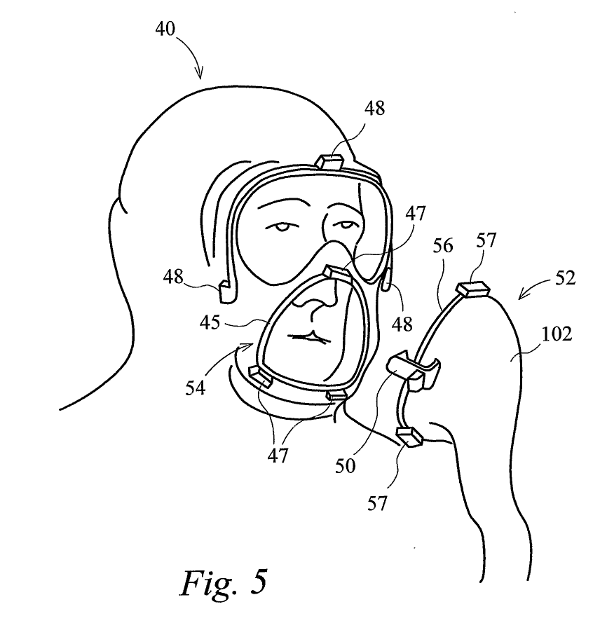

FIG. 5 shows a variant of the hood shown in FIG. 4;

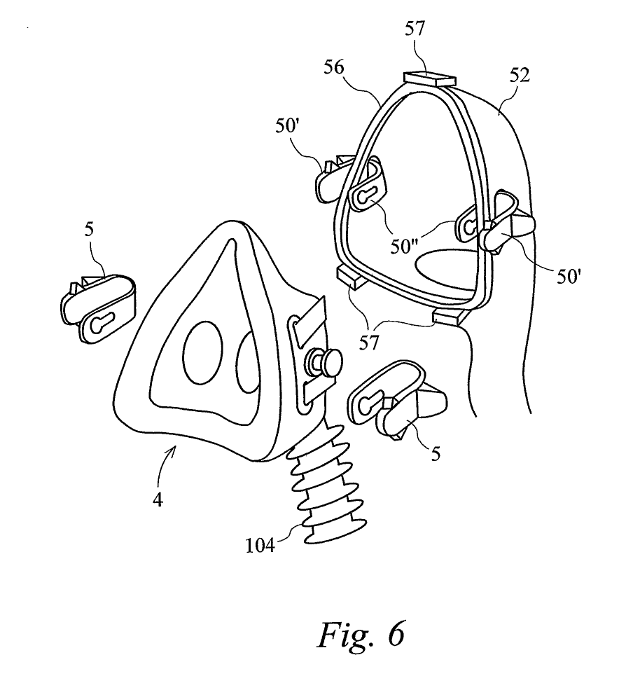

FIG. 6 shows a mechanism by which a mask may be fitted in a mouth and nose portion of the hoods shown in FIGS. 4 and 5;

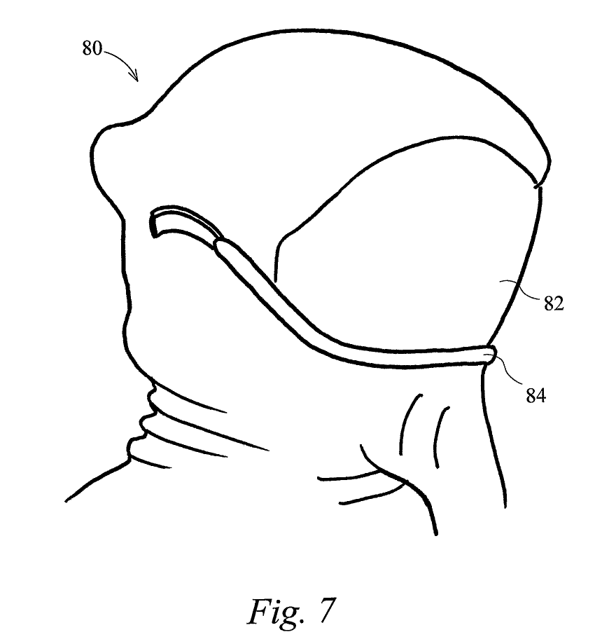

FIG. 7 shows a further hood adapted to be worn over a helmet;

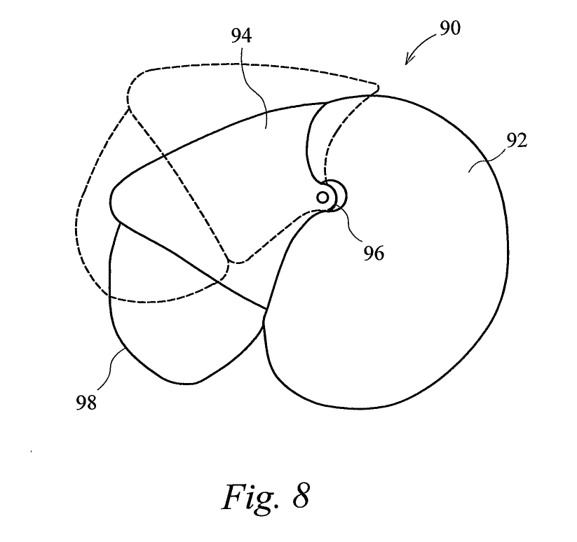

FIG. 8 illustrates a helmet having a raisable visor, showing the visor in its raised position in dotted lines;

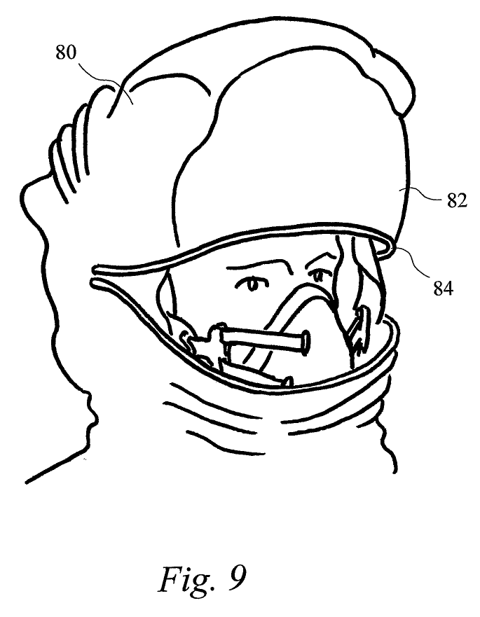

FIG. 9 shows the hood of FIG. 7 with the seal released and the visor of the helmet raised;

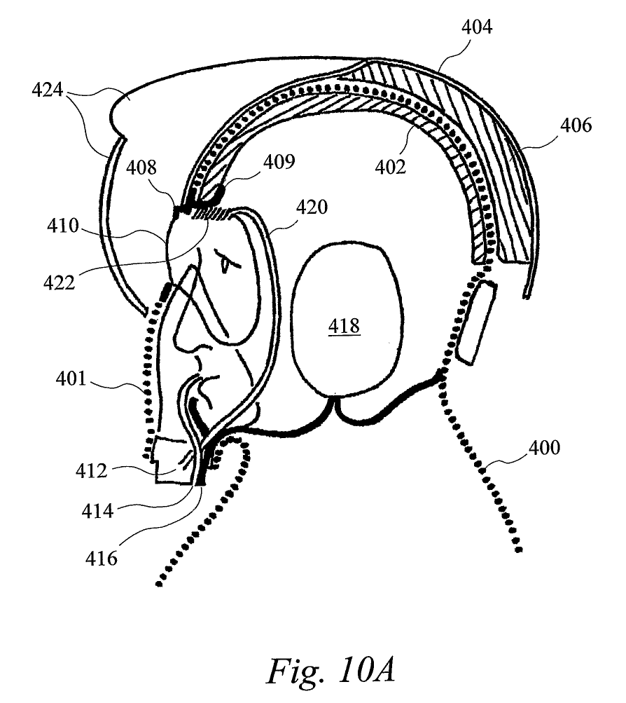

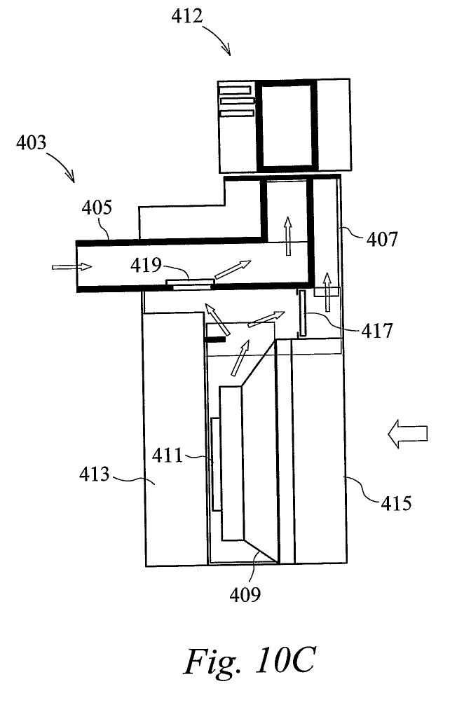

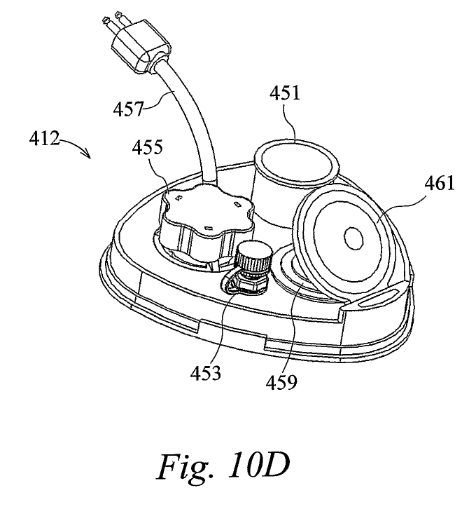

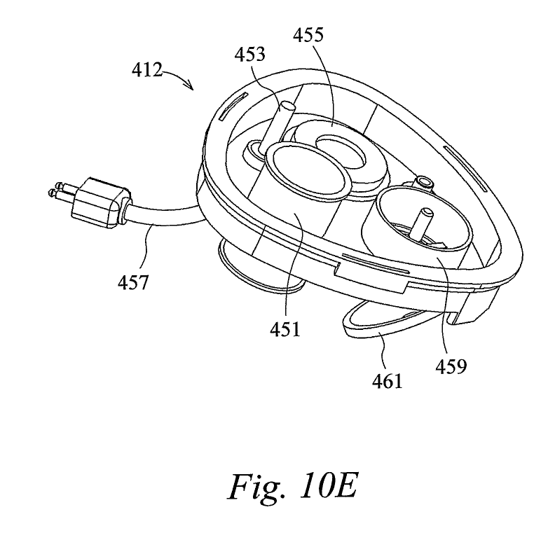

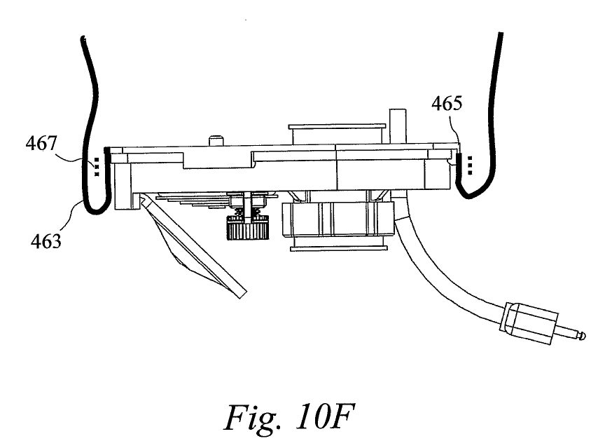

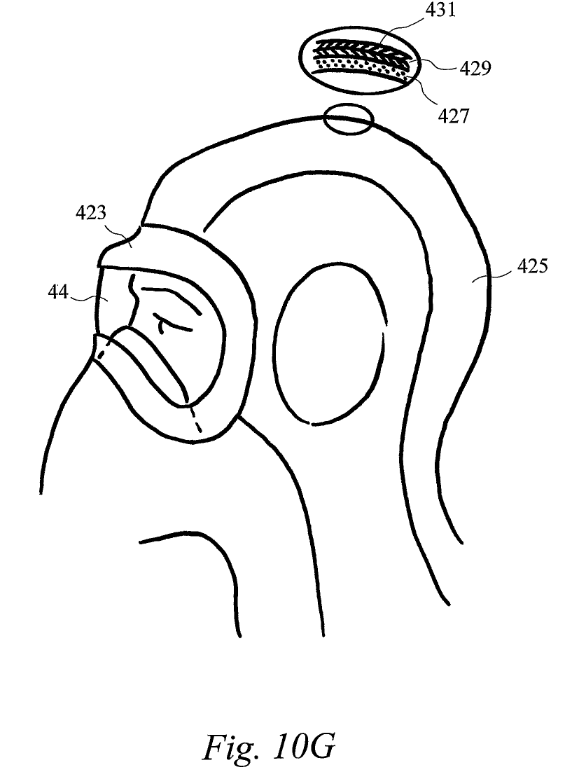

FIG. 10a shows a further example in which the hood is worn between the helmet and a custom-fitted inner cap;

FIG. 10b shows further detail of a manifold adapted to be used with an environmental protection hood;

FIG. 10c shows schematically details of fluid flow through a supply gas assembly for the manifold;

FIG. 10d shows schematically a view of an exterior of a manifold;

FIG. 10e shows schematically a view of an interior of the manifold of FIG. 10d;

FIG. 10f shows schematically view of the connection between the manifold of FIGS. 10d and e and an environmental protection hood;

FIG. 10g shows an illustration of an environmental protection hood;

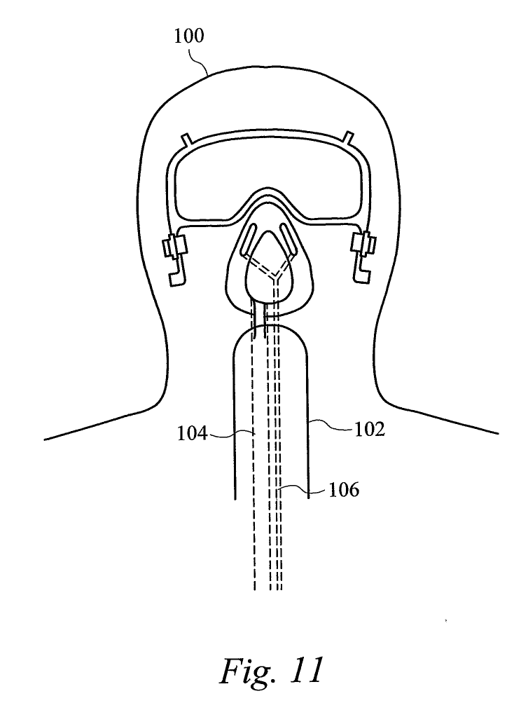

FIG. 11 illustrates a hood having a sleeve for hoses for providing air to a respirator mask and demisting air;

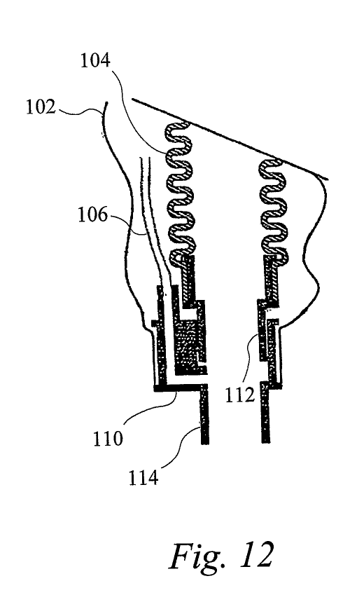

FIG. 12 is a schematic representation of a connection assembly at the distal end of the sleeve for connecting hoses running through the sleeve to an air supply of an aircraft;

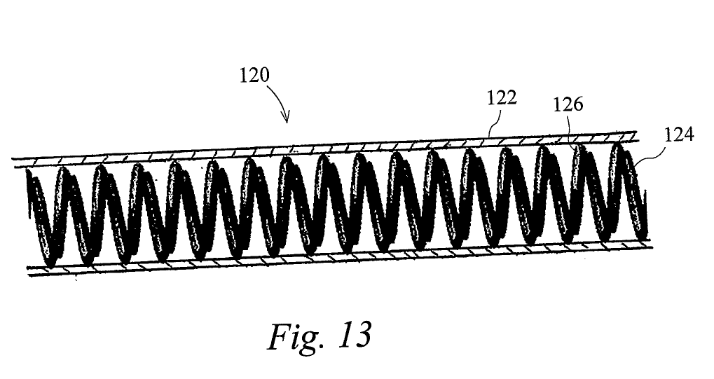

FIG. 13 is a part section through a first hose;

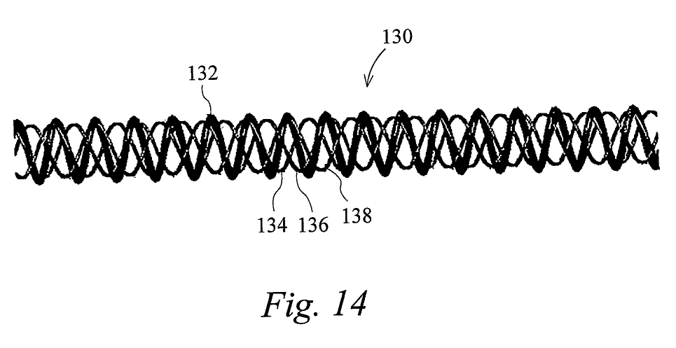

FIG. 14 is shows the structural helices of a second hose;

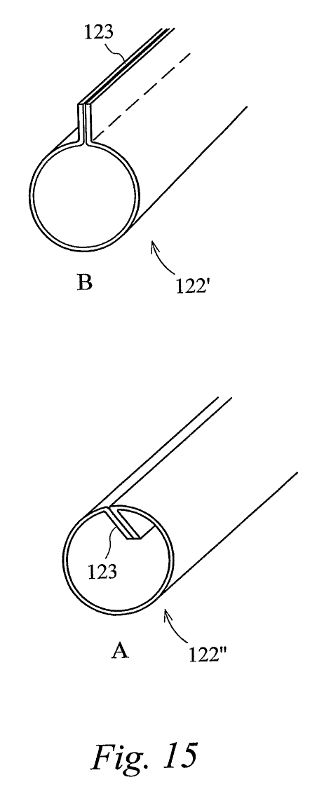

FIG. 15 show a sleeve forming the enclosure of a hose having an external seam (FIG. 15A) and an internal seam (FIG. 15B);

FIG. 16 shows a mask suitable for use with the hoods and hoses shown in the previous Figures;

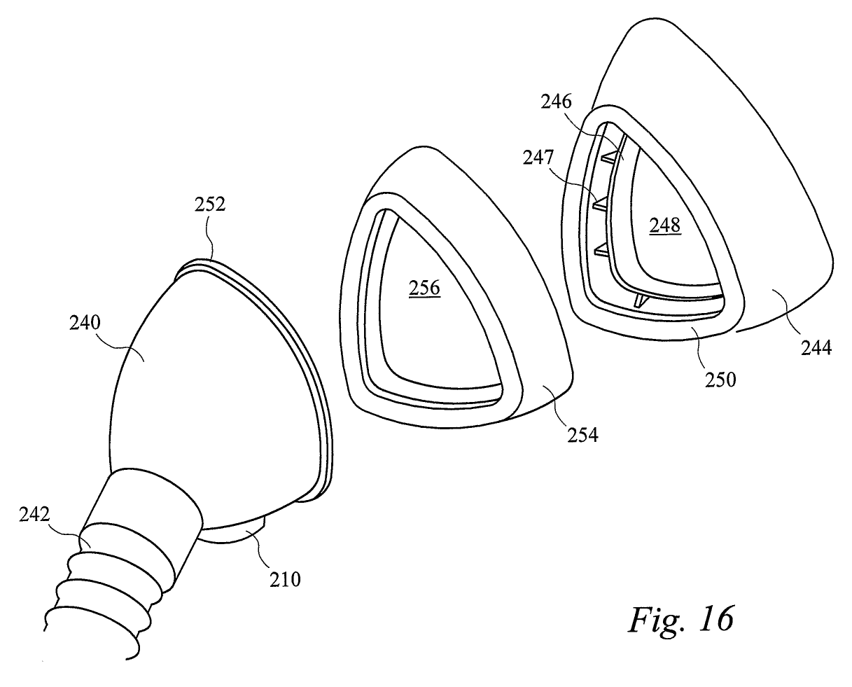

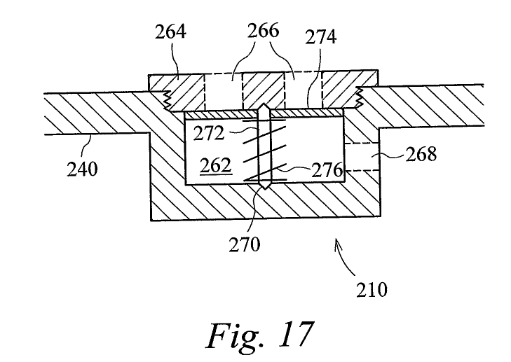

FIG. 17 is a simplified schematic representation of a valve forming part of the mask shown in FIG. 16;

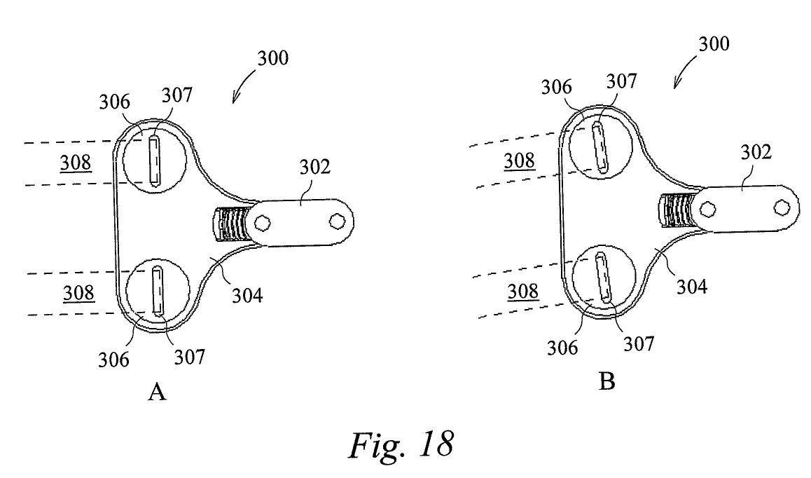

FIG. 18 shows a first embodiment of a fitting for attaching a mask to a helmet or an under-helmet hood;

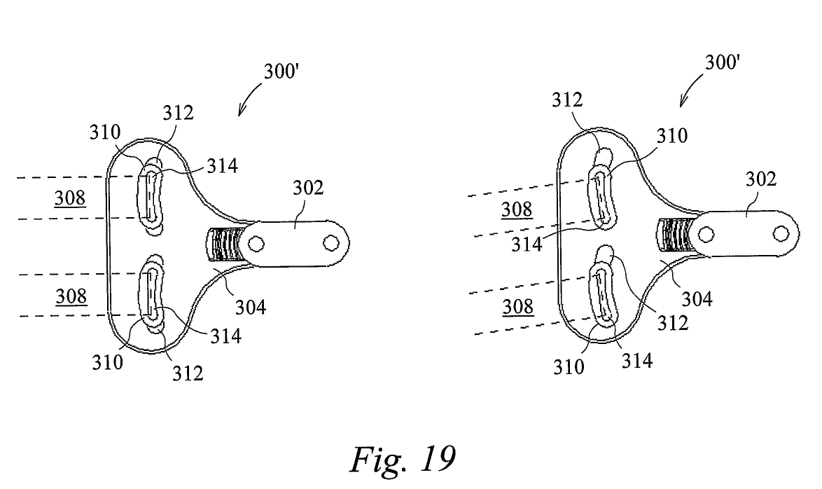

FIG. 19 shows a second embodiment of a fitting;

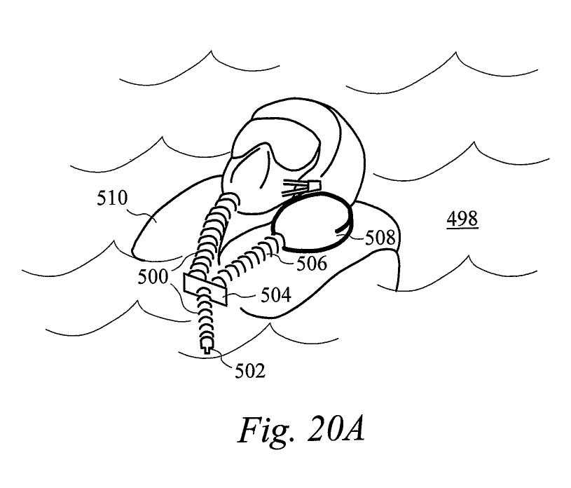

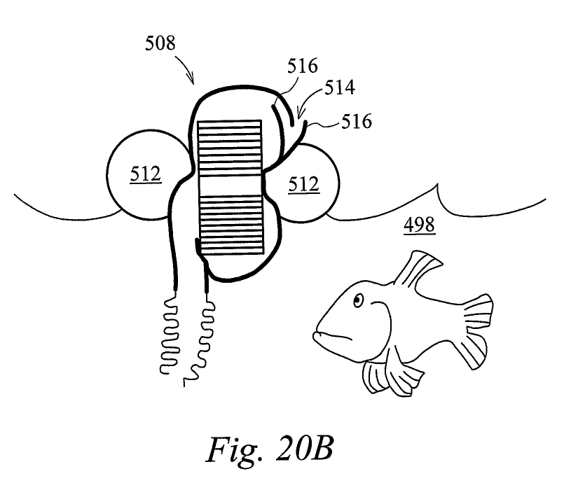

FIG. 20A illustrates the use of an air supply system having a secondary air source above water level; and

FIG. 20B shows a buoyant secondary air source;

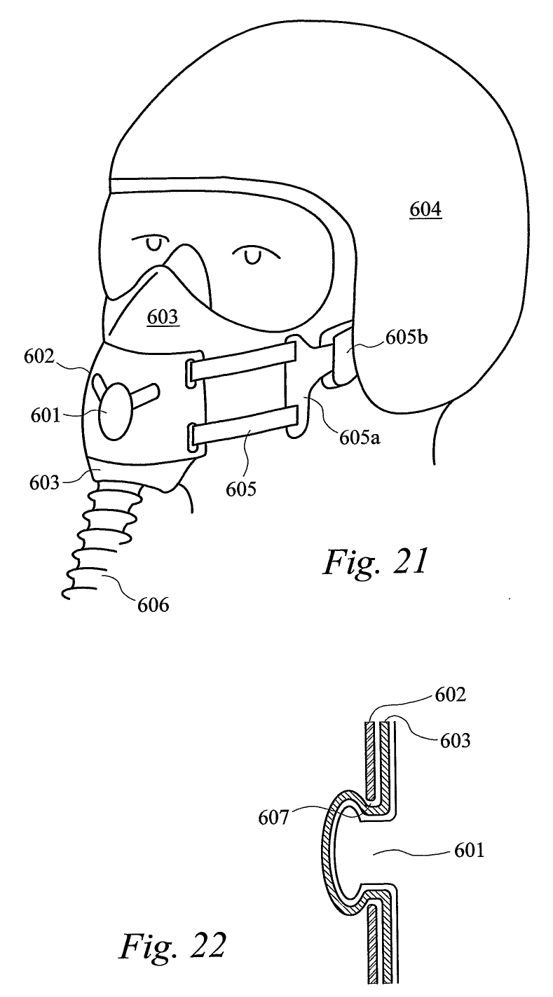

FIG. 21 diagrammatically shows a mask embodying the an aspect of the invention;

FIG. 22 is an axial section through the fixing arrangement for the mask;

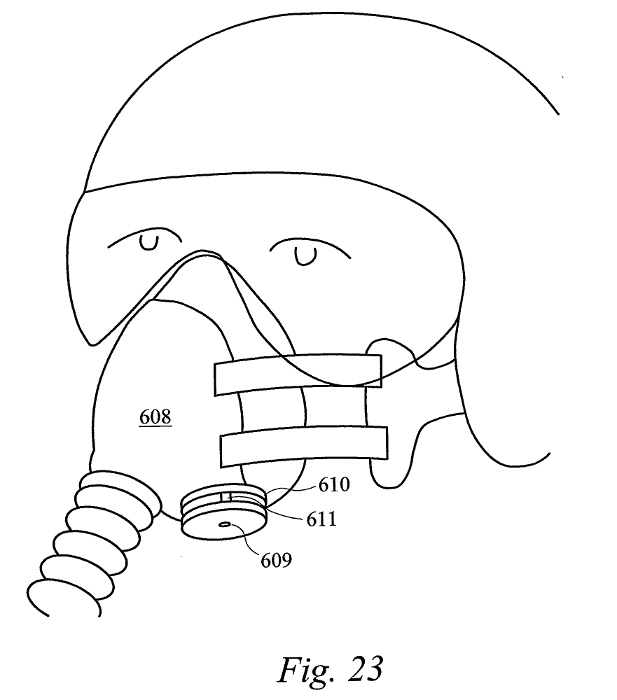

FIG. 23 diagrammatically shows a mask embodying a further aspect;

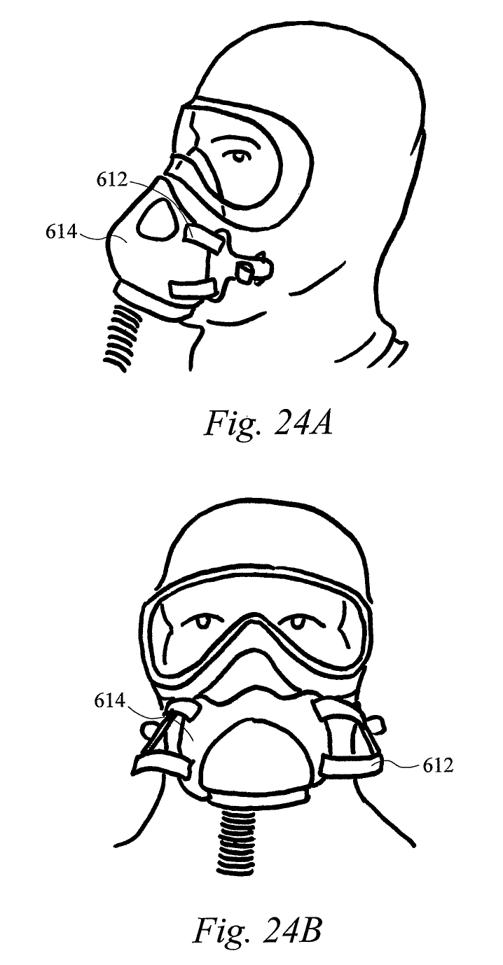

FIG. 24a illustrates one type of mask in use; and

FIG. 24b illustrates a further type of mask in use.

A first example of a system allowing a wearer of a helmet also to wear an environmental protection hood will first be described, in which the hood is to be worn under the helmet. A second example in which the hood is worn over the helmet will then be described, followed by a third example in which the hood is disposed between a custom-fitted inner liner and the outer shell of the helmet. Finally, further features which may be provided in connection with one or more of the examples will be described.

FIG. 1 shows an impact-resistant and energy-absorbing helmet 2. A respiratory mask 4 is provided to allow the user to breathe in conditions where this would otherwise be difficult or impossible, and a visor 6 depending from a helmet-mounted display unit or boss 7 is provided to shield the wearer's eyes.

FIG. 2 is a schematic section through the helmet 2 with the mask 4, boss 7 and visor 6 removed. The helmet comprises an outer shell 8 covering a personalised cap 10 comprising a crown portion 12 (to cover the crown of the head of a wearer of the helmet) and a brow portion 14 (to cover the brow). The crown and brow portions 12, 14 of the cap 10 are contiguous with one another. The outer surfaces of the cap 10 are profiled to conform to the profile of the inner surface of the outer shell 8, such that relative movement of the cap 10 and the outer shell 8, when in use, is minimised.

The crown and brow portions 12, 14 of the cap 10 are formed in accordance with data relating to the size and shape of the head of an intended user of the helmet obtained by gauging the profile of the wearer's head, for example by a measurement device operating by direct measurement or by a non-contact method such as optical scanning, without an environmental protection hood so that when the wearer for whom the helmet 2 was constructed wears the helmet without such a hood, it fits closely to his head, and the possibility of movement of the helmet relative to the head is minimized.

In addition, an alternative brow portion 14′ (shown in dotted lines) of the cap 10 is provided. The outer surface of this alternative brow portion is also profiled to conform to the profile of the inner surface of the outer shell 8. However, the inner surface of the alternative brow portion 14′ is formed in accordance with data relating to the size and shape of the head of the intended user of the helmet while wearing an environmental protection hood so that when the wearer wears the helmet with such a hood, the helmet fits closely to his head and, again, the possibility of movement of the helmet relative to the head is minimized. In some embodiments it may be necessary also to change the crown portion to accommodate the environmental protection hood; then the alternative crown portion 12′ (again shown dotted) is formed based on data defining the size and shape of the user's head when wearing the hood. In the preferred embodiment, the alternative brow portion 14′ is shaped to accommodate a frame of the environmental protection hood (described in more detail below).

At the interface between the crown and brow portions 12, 14 of the cap 10, the portions engage with one another or interlock to inhibit relative movement of the portions during use of the helmet. However, the portions may be removed from the outer shell 8 independently of one another; in particular, the brow portions 14, 14′ of the cap may be interchanged without disturbing the crown portion.

Both portions of the cap 10 are formed of an energy or impact absorbing material (for example, expanded polystyrene) in order to protect the wearer from injury in the event of an impact. Furthermore, the crown portion 12 of the cap is thicker than the brow portion 14, 14′ and, in a particular embodiment, the portions are formed of different energy or impact absorbing materials having different impact properties. The outer shell 8 of the helmet also comprises crown and brow portions 16, 18 respectively, which correspond approximately to the crown and brow portions of the cap 10. The outer radius of the shell brow portion 18 is less than that of the shell crown portion to permit the attachment over the brow portion of a helmet mounted display equipment. In conjunction with a thinner brow portion 14, 14′ of the cap 10, this allows the display equipment to be mounted close to the eyes of the wearer of the helmet.

In the preferred embodiment, the measurement device by means of which data relating to the size and head of the intended wearer of the helmet is a non-contact device (for example which scans the head of the wearer of the helmet optically). In order to ensure accurate fitting of the helmet 2 and control over the attitude at which it sits upon the head of the wearer, the positions of the eyes of the wearer relative to one another and to the measured portion of his head are determined.

An environmental protection hood for use in conjunction with a helmet having the above-described personalised cap will now be described.

FIG. 3 shows an environmental protection hood 40 to be worn under a helmet. The hood is formed of a flexible material and is adapted to be closing-fitting to the head of a wearer.

An aperture 42 in the flexible material is provided in a region of the hood intended to be situated in front of the eyes of the user when the hood is in use. The material of the hood at the periphery of the aperture is attached to a rigid frame 44, by means of which the shape of the aperture is maintained. The aperture is sealed by a removable clear window 46 through which a wearer of the hood may see.

Upper and lower clips 48, 50 are provided on the frame adjacent the brow and the cheeks respectively of a wearer of the hood for engaging with clips in a helmet such that the frame and the window are positively located relative to the helmet. In a preferred embodiment, the lower clips 50 are adapted to engage with mask receivers in a helmet under which the hood is worn (described in further detail below with reference to FIG. 6).

The hood further comprises a mask region 52, intended to be situated adjacent a respiratory mask worn by the wearer of the hood, such that the mask is enclosed with the head of the wearer. At sides of the mask region, that is to say in locations on the inner surface of the hood, adjacent the cheeks or the ears of a wearer of the hood, there are provided receivers for receiving bayonets for locating the mask adjacent the mouth of the wearer. While the receivers may be attached to the frame, in a preferred embodiment the receivers are not attached to the frame and the flexibility of the material between the receivers and the window allows the receivers to move relative to the window.

In a further embodiment, shown in FIG. 4, the mask region of the hood is removable. In this embodiment, the frame 44 (the main frame) additionally defines an aperture 54 in the region of the mouth and nose of the wearer. The mask region of the hood comprises a further frame 56 (the mask frame) having a shape corresponding to that of the main frame such that the mask frame seals against the main frame. Clips 57 are provided on the mask frame 56 which engage with clips 47 on the main frame 44 to positively locate and seal the mask frame against the main frame. In this embodiment, the lower clips 50 are provided on the mask frame 56.

In a variant of this embodiment (shown in FIG. 5), the aperture 54 in the region of the mouth and nose of the wearer is not formed by the main frame 44 but by a secondary frame 45.

Turning to FIG. 6, a mechanism for locating the mask within the hood shown in FIG. 5 will be described. The mask region 52 of the hood comprises bayonets 50 for engaging with a helmet and a mask. The bayonets 50 extend through the mask region of the hood, which is sealed around them, to provide clips on the inside and the outside of the hood. On the outer surface of the mask 52, the bayonets 50 comprise clips 50′ which are adapted to engage with the receivers in a helmet to which the bayonets 5 of the mask 4 are ordinarily attached when an under-helmet hood is not worn. The bayonets 5 of the mask 4 (which may be the same mask which is used when a hood is not necessary and which may be custom fit to a wearer) are removed, and the mask instead engages with the interior clips 50″ of the hood bayonets 50. The air hose 104 attached to the mask 4 is inserted into the sleeve 102 as described above.

As indicated above, in an alternative embodiment, the interior clips 50″ and the exterior clips 50′ are not rigidly located relative to one another, in order to allow relative movement of the mask and the helmet.

The second example will now be described.

As indicated above, in this example, the hood is worn over a helmet for example as shown in FIG. 1.

FIG. 7 shows a hood 80 being worn over a helmet (such as that shown schematically in FIG. 8). The hood is formed largely of a flexible material which allows the hood conform to the shape of the helmet over which it is worn. A transparent window or visor 82 is provided in an eye region of the hood, through which the wearer of the hood may see. A releasable seal 84 is provided along or adjacent the lower edge of the visor 82. By releasing this seal, an opening may be made in the hood.

Turning to FIG. 8 an example of a helmet with which the hood may be worn comprises a head portion 92 and a helmet-mounted display unit (HDU) mounted on the head portion at pivots 96 so that the HDU may be raised from a first position to a second position (shown in dotted lines). A transparent visor 98 depends from the HDU 94.

When the hood 80 is worn with such a helmet 90, the hood visor 82 and the helmet visor 98 are both situated in front of the eyes of the wearer. Adjacent the periphery of the hood visor 82 are provided clips which engage with the boss 94 to locate the visors 82, 98 in relation to one another. Thus, when the seal 84 is released, both the hood visor 82 and the helmet visor 98 may be raised together, as shown in FIG. 9.

The third example will now be described with reference to FIG. 10, which illustrates features of the example schematically.

As indicated above, in this example, the hood 400 (shown in dotted lines) is worn between a custom-fitted inner cap 402 and the shell 404 of a helmet. The custom-fitted inner cap 402 extends across the top of the head of a wearer from a position roughly adjacent the brow to a position above or roughly adjacent the external occipital protuberance. An impact attenuating liner 406 extending roughly from a position roughly adjacent the crown of the head of the wearer to a position above or roughly adjacent the external occipital protuberance of the wearer is fixed inside the shell 404 of the helmet such that a portion of the hood 400 adjacent the top and back of the head of the wearer is disposed between the cap 402 and the liner 406. In order to be able to locate the helmet accurately and repeatable on the head of the wearer, the custom-fitted cap 402 is shaped on its inner surface to fit closely the head of the wearer, and on its outer surface to fit inside the shell 404 and the liner 406 of the helmet with a hood 400 disposes therebetween.

A rigid frame 408 (having features in common with the rigid frame 44 shown in FIG. 3) is provided around an aperture in the hood 400, in which is removably located a window 410. The frame 408 comprises on its inner side (with reference to the helmet) a generally upward-opening, U′-shaped channel 409 which receives the forward edge of the cap 402, rigidly locating relative to one another the cap 402, the window 410 and the shell 404 of the helmet.

A portion 401 of the hood 400 adjacent the mouth and nose of the wearer is shaped to allow a mask (not shown) to be worn under the hood (as described above). An oxygen mask manifold 412 is provided in an aperture adjacent this portion 401 of the hood 400. The manifold 412, shown in more detail in FIG. 10b, forms the sole point of entry for services into the interior of the hood. On its external side, it includes fittings to receive an air hose in order to supply air to the mask and, via a hose 420, to a plurality of jets 422 formed in the frame 408 adjacent the channel 409, the jets being arranged to direct air onto the inner surface of the window 410 to reduce or eliminate misting. The manifold also comprises a connection for a drinking tube 414 for providing a liquid to the wearer. Communications leads 416 extend from a microphone (not shown) located in the mask and earphones 418 worn by the wearer down through the manifold 412.

The manifold may be covered by the material of the hood, and may be welded into the hood. The presence of the manifold minimises the numbers of penetrations of the hood in order to convey services to the wearer.

A helmet mounted display 424 for providing the wearer with information is provided on the forward side of the helmet.

The air flow through a supply conduit assembly 403 leading to the manifold 412 is shown in further detail in FIG. 10c. The assembly comprises a breathing supply tube 405, which supplies almost pure oxygen for a wearer to breathe, and an air hose 407 which supplies air to the demisting jets 422 described above. The oxygen mix supplied to the wearer is conditioned. The air supplied to the demister is not conditioned, but is filtered, as described below.

The breathing supply tube 405 is integrated with the air hose 407. Preferably, as shown in FIG. 10c, the breathing supply tube is disposed within (preferably concentrically within) the hose 407. This arrangement means that only a single hose connection to the manifold 412 is necessary. The tube 405 and hose 407 are both made from a lightweight material.

The air hose 407 comprises an impeller 409 powered by a brushless motor 411. The brushless motor is battery powered and the batteries disposed in a battery compartment 413. In normal circumstances the fluids in the breathing supply tube and the air hose do not mix. Cockpit air is drawn by the impeller 409 through a filter 415 and a non-return valve 417 to the manifold 412.

However, when the wearer undergoes exertion the oxygen supplied by the breathing tube 405 may become insufficient. Internally the air hose 407 and the breathing supply tube 405 are connected by a normally closed one-way top-up valve 417 and as the wearer breathes more heavily the pressure in the tube falls. At a given pressure, the top-up valve 419 opens, to allow air from the air hose 407 to enter the breathing supply tube 405, and supplement the oxygen supply to the wearer. The non-return valve 417 prevents fluid flowing back from the hood under these circumstances.

FIG. 10d-f show the manifold in more detail. The manifold 412 comprises a variety of spigots: a oxygen supply spigot 451, a connector for a drinking straw arrangement 453, a dump-valve 455, a communications lead 457, and an exhaust valve 459. The exhaust valve has a cover 461 which the pilot may close easily with a gloved hand to ease pressure in the ears as described for part 609 of FIG. 23 hereinafter. In this embodiment of the manifold an alternative demisting system is used whereby a small amount of the oxygen supply is used to demist the system via a separate bleed from the oxygen spigot. Custom rubber hoses (not shown) connect the various spigots with the masks. A different set of rubber hoses may be used for interconnections with the various masks. The communications lead connects the mask microphone and headset to the external world. The connection between the environmental protection hood and the manifold is shown in FIG. 10f. A snout for 463 of the environmental protection hood is secured over a lip 465 of the manifold using a cable tie 467.

The hood (as described in any of the preceding examples) may be formed of a breathable (permeable one-way) fabric to increase wearer comfort. It may also be impregnated with a catalyst to promote self-decontamination when the hood has been worn in harmful environments. In order to increase wearer comfort still further, the hood may be formed of a translucent material to reduce or eliminate a claustrophobic reaction by a wearer.

FIG. 10g shows an arrangement which increases wearer comfort still further. A goggle arrangement 421 is surrounded by a transparent (or translucent) plastics material 423. This increases the wearer's peripheral vision. It also makes manufacture of a hood 425 easier, as the goggles 421 may be glued or welded to the plastic surround 423, which in turn may be glued or welded to the otherwise-opaque hood 425.

The detail shown in FIG. 10d gives an example of materials which may be used for the hood 425. The hood 425 comprises a three layer structure, an inner layer 427 which comprises an absorptive comfort liner, a middle layer 429 which comprises a Lycra® fit/control layer, and an outer layer 431 which comprises a barrier fabric.

Turning to FIG. 11, a further system for providing air to a respiratory mask worn together with the hood will now be described. This system is applicable equally to the under-helmet hood 40 and the over-helmet hood 80 described above.

The hood 100 comprises a sleeve 102 formed of the same flexible material as the main body of the hood. A hose 104 for feeding air to a respiratory mask 105 worn by the wearer of the hood is inserted into the sleeve and the proximal end of the hose 104 is connected to the mask in a known manner.

Also running through the sleeve is a further hose 106 for supplying demisting air to the window 101 of the hood 100.

At the distal end of the sleeve is provided a connection assembly 110 (see FIG. 12). The connection assembly comprises a socket 112 on the inside of the sleeve in flow communication with a plug 114 on the outside of the sleeve. The socket 112 is adapted to receive and retain the hose 104 for supplying air to the mask 105 (which may, for example, be as currently used to supply air to respiratory masks in aircraft) and the further hose 106 for supplying demisting air. The sleeve is sealed around the connection assembly 110, but air may pass into the hoses from the air supply of an aircraft via the connection assembly. In this way, air may be supplied to the mask 105 by means of a hose which is enclosed in the hood. In the case of a hood intended to be worn over a helmet, cables for power, data and communications also reach the helmet via a sleeve (for example, the sleeve 102 shown in FIGS. 11 and 12.

A hose suitable for use with the above-described systems will now be described with reference to FIGS. 13 and 14.

FIG. 13 shows a first hose 120 comprising an enclosure means in the form of a silicone rubber wall 122 shown in cross-section, and structural means, for maintaining the structure of the hose, in the form of two coaxial helices, one 124 running inside the other 126. The inner helix 124 is right-handed while the outer helix 126 is left-handed, and their radii are similar such that there is contact between the helices where they cross one another. In some embodiments, the helices may be bonded to one another. Furthermore, the helices may float freely within the outer wall 122, they may be bonded to it along their length (for example, using a thin film adhesive), or they may be constrained relative to the wall at either or both ends. In a particular example, the structural means is formed as a tape which is wound around the helices.

The helices are formed of a thermoplastics material such as nylon, polyethylene or polypropylene by extrusion.

FIG. 14 shows an alternative structural means 130 comprising a left-handed outer helix 132 around three right-handed inner helices 134, 136, 138. The inner helices 134, 136, 138 have smaller cross-sections (i.e. the cross-section of the material forming the helix, rather than of the helix itself) than the outer helix 132. The helices are again of extruded thermoplastics material.

Further embodiments are possible having one or more helix in each direction, the helices being of various cross-sections and pitch and in various arrangements. However, the cross-sections, pitch and arrangement of the helices are chosen so as to minimise the torque around the axis of the hose produced when the hose is compressed or stretched. For example, in the arrangement shown in FIG. 11, the helices are of identical cross-section and identical pitch.

In further embodiments intended for use in the presence of contaminants to which silicone is transparent, the enclosure means (122′ and 122″ in FIG. 15) of the hose may be formed from an elongate sheet of a material, e.g. an impermeable fabric, the long edges of which are sealed together, e.g. stitched and bonded or welded, to produce a sleeve 122′, 122″ which may be used with the seam 123 external (see FIG. 15A) or inverted such that the seam 123 is internal (FIG. 15B). The sleeve may then be fitted (or indeed it may be formed) around the outside of the structural means (e.g. helices as described above) or it may be inserted within the structural means, at least portions of which are then bonded to the sleeve such that they maintain the lumen of the sleeve.

In yet further embodiments (not shown), the enclosure means may be formed of an elongate material (e.g. an impermeable fabric) which is wound around the structural means in an overlapping helical configuration and bonded in the overlapping regions to provide an impermeable enclosure.

A mask will now be described which may be used in conjunction with the above-described systems.

With reference to FIG. 16, the mask comprises a rigid unit 240 which houses all of the common elements of the respirator, such as an inspiratory valve unit, an expiratory valve and a communications microphone. The unit 240 is connected to a supply hose 242 for the supply of breathing gas to a wearer, such as an airman. The unit 240 is formed by injection moulding of a thermoplastics material such as nylon, and is moulded to have interior surfaces of the mask which serve as valve seats for the inspiratory valve and expiratory valves, and cavities or depressions which serve as pressure chambers for the valves.

FIG. 17 is a simplified schematic representation showing a valve 210 in the wall of the unit 240. The valve comprises a cavity 262 defined in the wall of the unit 240, which serves as a chamber of the valve. The chamber is closed by a cover 264 which screws into the opening in the chamber 262. The cover comprises openings 266 to allow exhalate into the chamber, and a side wall of the chamber comprises a further opening 268 to allow the exhalate to leave the chamber.

Opposing depressions in the cover 270 and the wall of the unit 240 serve to locate a shaft 272 upon which is mounted a valve disc 274. The disc 274 is slidable along the shaft 272 and is urged by a spring 276 towards the cover 264 where it seals the openings 266, preventing air from outside the mask entering the mask via the chamber 262.

While the valve shown is simplified in order to provide a clear example, the principle is equally applicable to inspiratory and expiratory valves, including valves through which air is to be breathed under pressure.

The unit 240 is a common element of the breathing mask, in that it is supplied in common to many airmen regardless of facial size and/or shape. The unit 240 is connected to a pre-formed unit 244 having a flexible body moulded from, for example, rubber material, for sealing to an airman's face. The inner surface of the body may be moulded with features 247 which prevent the reflex edge of the sealing surface of the unit from becoming inverted under pressure.

The pre-formed unit 244 is a sized component, which may also be shaped to suit differing racial characteristics, selected from a range of such units 244 according to the size and/or shape of the wearer's face. The pre-formed unit 244 could even be bespoke to a particular user, being manufactured to suit the contours of an individual's face.

The units 240, 244 are assembled by threading the supply hose 242 though aperture 248 in the unit 244 and drawing the unit 244 around the unit 240 so that lip 250 of the unit 244 engages the raised edge 252 of the unit 240. A rigid clamping unit 254, which may be formed from moulded plastics material, is, like the unit 244, a sized component and selected from a range of similar units in accordance with the particular unit 244 chosen for the airman. The clamping unit 254 is assembled to the units 240, 244 by similarly threading the supply hose 242 through the aperture 256 and drawing the clamping unit 254 around unit 240 to engage the unit 244. The clamping unit 254 may be secured by a snap-fit or by any conventional fastening.

Finally, fittings to allow a mask to be located within a helmet or an under-helmet hood are described with reference to FIGS. 18 and 19.

FIG. 18 shows a first embodiment of a fitting which comprises an elongate bayonet assembly 302 adapted to engage with receivers in a helmet, and a steelwork portion 304. The steelwork portion 304 comprises two rotatably mounted discs 306, each having a slot 307 through which may be passed webbing 308 for attaching the fitting to the mask. FIG. 18A shows the fitting with the discs oriented such that webbing passing through the discs extends in a direction parallel to the axis of the bayonet assembly. In FIG. 18B, the same fitting is shown with the discs rotated slightly so that the webbing extends away from the axis of the bayonet assembly 302.

FIG. 17 shows a second embodiment of a fitting 300′, similar to that shown in FIG. 18 with the exception that, instead of discs, the steelwork portion 304 comprises arcuate inserts 310 slidably mounted in arcuate slots 312 having the same radius of curvature as the inserts 310, such that they may slide between the ends of the slots 312. Each of the inserts 310 contains a further slot 314 through which may be passed webbing 308 for attaching the fitting to the mask. FIG. 19A again shows the webbing extending in a direction parallel to the axis of the bayonet assembly 302. In FIG. 19B, the same fitting 300′ is shown with the inserts rotated slightly so that the webbing extends away from the axis of the bayonet assembly 302.

Finally, embodiments of a device to enable the wearer (e.g. aircrew) of an oxygen mask of the type with which the above-described items may be used (e.g. close-fitting such that the wearer may breathe only via the mask) to breathe in the event that they find themselves in water 498, for example, after having ejected over the ocean (see FIG. 20A).

Air is provided to the mask via a hose 500 a distal end of which is attachable to an aircraft air supply via a plug 502 and socket (not shown) arrangement. The hose 500 feeds a first inlet of a block 504 provided in the hose adjacent the chest of the user of the mask. When in use in an aircraft, air is provided to the hose by the aircraft air supply under pressure, and a pressure switch in the block 504 maintains (by action of the air pressure) flow communication between the plug 502 and the mask when air pressure at the first inlet of the block is greater than a threshold pressure. However, when the air pressure at the first inlet falls below the threshold pressure, the pressure switch is released and is biased to allow flow communication between the mask and a further hose 506 connected to a second inlet of the block 504. At its distal end, the further hose is connected to a snorkel unit 508 which is fixed to the shoulder region of the wearer's buoyancy device 510 by releasable means, such as a thread having a low tensile strength.

The snorkel unit additionally comprises a flotation bladder 512 (see FIG. 20B) which is inflated automatically upon or shortly after contact with water by a CO₂ canister having a soluble spring trigger of a known type (for example as used in air line life vests) in which, upon contact with water, a trigger of a soluble material dissolves releasing a bayonet which is biased towards the canister. The bayonet punctures the canister, releasing the pressurised CO₂ and inflating the bladder. The bladder is arranged such that when inflating it causes the snorkel unit to be released (e.g. by snapping the thread holding the unit to the life vest) and to float at the surface.

An inlet 514 of the snorkel unit 508 allows air to enter, while baffles 516 prevent or inhibit the ingress of water, for example in rough seas.

A further mask will now be described which may be used in conjunction with the above-described systems.

Referring to FIG. 21, a pilot is provided with an environmental protection hood 603 worn under a helmet 604. A breathing mask incorporates a face piece which is worn under the hood (and not visible in FIG. 21) and a cover or exoskeleton 602 which is worn externally of the hood and is connected to the helmet by strapping, 605 and a bayonet fitting 605a which is retained in a receiver 605b attached to the helmet 604, as for example in GB 2313399. A hose 606 supplies air to the face piece of the mask.

This arrangement enables different types of masks to be used with an environmental protection hood.

The face piece is secured to the cover by an arrangement incorporating a stud 601 provided on the face piece and capable of inter-fitting with an opening 607 in the cover. The stud is of mushroom-like shape and has an enlarged head as shown in FIG. 22 so as to be a snap-fit in the opening, with the material of the hood trapped between the stud and the cover. The stud may be readily snapped into the opening and released from it, but reliably secures the two parts of the mask when interlocked with it.

Referring now to FIG. 23, a breathing mask is provided with an expiratory valve having an outlet port 610 covered by a finger piece 609. The construction of the valve may be as described in UK Patent Application No. 0311338.8, but may alternatively be of any suitable known type. It is arranged to close as the wearer inhales, and to open as the wearer breathes out. When in its normal position the cover 609 does not interfere with this manner of operation but may be depressed to close the port 610 when it would normally be open.

In order to ease discomfort in the ears, the wearer of the mask may use the finger piece 609 to close the port and at the same time exhale strongly, and then release the finger piece.

The finger piece may take the form of a cover for the outlet port retained by a central spigot 611 and arranged to close the port when depressed. Alternatively the finger piece may be coupled to the valve and serve to over-ride and close it when it would normally be open. The finger piece may be so shaped as to be easily identifiable by touch, as by being dished.

FIGS. 24a and 24b illustrate different types of mask in use. Straps 612 attach an outer component, or exoskeleton 614, to the helmet when the wearer puts the helmet on, as also shown in FIG. 21 and described above. The use of such an exoskeleton enables different types of mask to be used interchangeably.

Statements in this specification of the “objects of the invention” relate to preferred embodiments of the invention, but not necessarily to all embodiments of the invention falling within the claims. The description of the invention with reference to the drawings is by way of example only. Each feature disclosed in the description, and/or the claims and drawings may be provided independently or in any appropriate combination. In particular, a feature of a subsidiary claim may be incorporated into a claim upon which it is not dependent.

Each feature disclosed in this specification (which term includes the claims) and/or shown in the drawings may be incorporated in the invention independently of other disclosed and/or illustrated features.

Statements in this specification of the “objects of the invention” relate to preferred embodiments of the invention, but not necessarily to all embodiments of the invention falling within the claims. The description of the invention with reference to the drawings is by way of example only.

The text of the abstract filed herewith is repeated here as part of the specification.

A personalised cap 10 for use with a protective helmet is disclosed, having crown and brow portions 12, 14. The brow portion 14 is removable independently of the crown portion 10, and an alternative brow portion 14′ is provided for use when a environmental protection hood is to be worn under the helmet. An alternative crown portion 12′ also may be provided.

A hood for use over a helmet and a hose for use to provide air to a respiratory mask, a mask and fittings for attaching a mask to a helmet are also disclosed. The environmental protection hood may comprise a manifold 412 having an element external to the hood, for receiving supply of services needed within the hood, and an element internal to the hood, for providing those services where required.

1-111. (canceled)

112. An environmental protection hood comprising a manifold having an element external to the hood, for receiving supply of a plurality of services needed within the hood, and an element internal to the hood, for providing those plurality of services where required.

113. A hood according to claim 112, wherein the external element has an inlet for receiving a breathing supply and wherein the internal element is adapted for feeding a breathing mask.

114. A hood according to claim 112, wherein the external element has an inlet for receiving a liquid.

115. A hood according to claim 112 wherein the services include electrical wiring for communications.

116. A hood according to claim 112, wherein the internal element is adapted for feeding a demisting jet of air for demisting or inhibiting misting of a window of the hood and/or for ventilating the hood.

117. A hood according to claim 113, wherein the internal element is adapted for feeding a demisting jet of air for demisting or inhibiting misting of a window of the hood and/or for ventilating the hood and wherein the external element has an inlet for receiving air disposed within the inlet for receiving a breathing supply or vice versa.

118. A hood according to claim 113 in combination with a supply conduit assembly comprising a breathing gas conduit, an air conduit and a diverter for diverting air from the air conduit to the breathing conduit if a supply of breathing gas is insufficient.

119. A hood according to claim 118 comprising a powered impeller for increasing air pressure in the air conduit.

120. A hood according to claim 118, wherein the air conduit comprises a filter for removing contaminants from the air passing therethrough.

121. A hood according to claim 118, wherein the diverter comprises a normally-closed valve between the breathing gas conduit and the air conduit.

122. A hood according to claim 118 comprising a non-return valve to prevent air flowing back from the hood when air is diverted to the breathing conduit.

123. A hood according to claim 112, wherein the manifold comprises a breathing outlet port, a valve associated with the outlet port, the valve opening when a wearer of the hood exhales, and a mechanism operable by the wearer for closing the port when the wearer exhales.

124. A hood according to claim 123, wherein said mechanism comprises a cover for the port, the cover being capable of being depressed or otherwise moved manually to close the port.

125. A hood according to claim 123, wherein the cover is so shaped as to be readily identifiable by touch.

126. A hood according to claim 112, in combination with a protective helmet having an outer shell and an inner cap, the hood being disposed between the shell and the cap.

127. A hood according to claim 126, wherein the hood has a window aperture, and location formations adjacent the aperture for engaging with the cap and the helmet.

128. A breathing mask for use with an environmental hood, the mask including a component for location within the hood and a component for location externally of the hood, one of the components being provided or associated with a projection capable of being pressed into the material of the hood, and the other component having an opening for receiving and retaining the projection and the portion of the hood to which it is applied.

129. A breathing mask as claimed in claim 128, wherein the projection has an enlarged head which is shaped to be retained in the opening.

130. A breathing mask as claimed in claim 129, wherein the opening is defined by resilient material so that the projection is a snap-fit therein.

131. A breathing mask having an outlet port, a valve associated with the outlet port, the valve opening when a wearer of the mask exhales, and means operable by the wearer for closing the port when the wearer exhales.
